(19) United States
(12) Patent Application Publication
(10) Pub. No.: US 2014/0111000 A1
(43) Pub. Date: Apr. 24, 2014

(54) POWER KIT FOR A VEHICLE

(71) Applicant: John R. Cooney, Midland, MI (US)

(72) Inventor: John R. Cooney, Midland, MI (US)

(21) Appl. No.: 13/659,558

(22) Filed: Oct. 24, 2012

(51) Int. Cl. B60L 1/00; H01R 43/26

(52) U.S. Cl. 307/9.1; 29/857

(57) ABSTRACT

A power kit for receiving and distributing electrical power in a vehicle is provided. The power kit includes a control box which receives alternating current (AC) power and direct current (DC) power and outputs 120 Volt AC to one or more outlets positioned in a passenger compartment of the vehicle. The kit also includes an AC cord with a socket for mounting on an exterior surface of the vehicle and an extension cord for connecting the socket with an outlet. DC cord connects the control box with the vehicle's battery, and at least one outlet cord connects the control box to the outlet(s). Each cord has a plug, and the control box includes a plurality of jacks. The plug and jack combinations are configured differently from one another such that the AC, DC and outlet cords can only be connected to their respective jacks.

### BACKGROUND OF THE INVENTION

1. Field of the Invention

The present invention relates generally to a power kit for receiving electrical power and for distributing electrical power throughout a vehicle.

2. Description of the Prior Art

Many vehicles including pontoon boats, recreational vehicles (RVs), pop-up campers, etc. have passenger compartments but are not wired to provide passengers in those compartments with electricity for powering various electronic devices (e.g. stereos, laptop computers, televisions, etc.). Consequentially, electrical power is typically not available when such vehicles are in motion. When such vehicles are stationary, such as when a pontoon boat is at a dock or an RV is at a campsite, a passenger will run an extension cord into the passenger compartment of the vehicle for powering their various devices. However, depending on the type of vehicle, this approach may present a number of drawbacks. For example, in a boat, the power source to which the extension cord is attached may not provide adequate grounding in the event that the end of the extension cord or the device being powered are exposed to water and short-circuit. In an RV or a camper, a door or a window might have to be left open for the extension cord to reach the passenger compartment, which could be undesirable for security, climate control and insect control purposes. Additionally, the extension cord approach is very utilitarian and may be unsightly while also forcing the passengers to keep their electronic devices within their cords' lengths of the end of the extension cord.

Adding an electrical system including one or more outlets to the passenger compartments of such vehicles is typically a complicated and time consuming process and often must be carried out by a professional electrician to ensure that the electrical system satisfies certain safety standards, such as American Boat and Yacht Club (ABYC) safety standards for electrical systems on boats. As such, this process is often very expensive and there still is a risk that even the professional did not install the electrical system correctly.

### SUMMARY OF THE INVENTION

One aspect of the present invention is to provide a power kit that can easily be installed in various types of vehicles even by a person with limited knowledge of electrical systems without any special tools or other expensive equipment while also satisfying safety standards, e.g. American Boat and Yacht Club (ABYC) safety standards for electrical systems on boats. According to this particular aspect of the present invention, the power kit includes a control box with an alternating current (AC) input jack for receiving electrical power from an AC power source, a direct current (DC) input jack for receiving electrical power from a DC power source (such as the vehicle's battery) and at least one outlet jack for distributing electrical power to an outlet. The power kit additionally includes an AC cord with an AC plug; a DC cord with a DC plug; and at least one outlet with an outlet cord and an outlet plug for supplying power to or carrying power away from the control box. The control box also includes a DC to AC inverter for converting DC electrical power to AC electrical power to be supplied to the at least one outlet when the control box is only receiving electrical power from the DC power source. The plug and jack combinations are configured differently from one another so that the AC, DC and outlet plugs can only be connected to their respective jacks on the control box. As such, the AC and DC power sources and the outlets may only be connected to the control box properly, which minimizes the risk of an electrical short-circuit or other problems that could result from an incorrectly installed electrical system. This feature allows the power kit to be packaged and sold as an aftermarket product for installation by a person without the risks usually associated with non-professionals working with electrical components, and the resulting electrical system conforms to ABYC standards.

According to another aspect of the present invention, a power kit for receiving and distributing electricity in a vehicle is provided. The power kit includes a control box with at least two input jacks for receiving electrical power from at least two power sources and at least one outlet jack for distributing electrical power to at least one outlet in the passenger compartment of the vehicle. The power kit additionally includes at least two outlets, each of which is electrically connected to an outlet cord having an outlet plug that is configured for attachment to the outlet jack(s) on said control box. Each of the outlets further includes an outlet box with an outlet jack shaped similarly to the at least one outlet jack on the control box for receiving the outlet plug of the other outlet. As such, each of the outlets is connectable to either the control box directly or to the control box via the other of the outlets. This feature is advantageous because it allows a user to more easily connect additional outlets to the control box. So long as at least one of the outlets is directly connected to the control box, the others can either be connected to the control box itself or to the other outlets in a “daisy chain” style connection. Any desirable number of outlets can receive power from the control box in this fashion.

According to yet another aspect of the present invention, a power kit for receiving and distributing electricity in a vehicle is provided. The power kit includes a control box with a plurality of input jacks for receiving electrical power from a plurality of electrical sources (such as an external AC outlet and a battery) and at least one outlet jack for distributing electrical power to one or more outlet in the passenger compartment of the vehicle. The power kit additionally includes a plurality of electrical input cords and at least one electrical output cord for attachment to the input and output jacks respectively of the control box. The control box has an L-shape with a long leg and a short leg extending orthogonally to one another, and the input and outlet jacks are disposed on the surface of the short leg that faces in the direction that the long leg extends. This feature is advantageous because the control box has an ergonomic shape which can fit into smaller, generally rectangular constraints than it otherwise could if the input and outlet jacks were disposed on any of the other surfaces of the control box. Additionally, the connection between the input and outlet cords and the control box is generally protected on two sides by the short and long legs of the control box to guard against an accidental disconnection of any of these cords. Even further, where the control box is mounted in a generally rectangular opening of the vehicle, access to attach and detach the input and output cords to/from the control box is provided.

According to still another aspect of the present invention, a method of installing a power kit in a vehicle having a battery and a passenger compartment is provided. The method includes the step of mounting one end of an AC cord on an exterior surface of the vehicle and wherein the other end of the AC cord has an AC plug. The method continues with connecting one end of a DC cord to the battery of the vehicle and wherein the other end of the DC cord has a DC plug. The method proceeds with mounting at least one outlet having an outlet cord with an outlet plug into a position within the passenger compartment. The method continues with the step of securing a control box to the vehicle wherein the control box has an AC input jack configured to receive only the AC plug of the AC cord and a DC input jack configured to only receive the DC plug of the DC cord and an outlet jack configured to receive only the outlet plug of the outlet cord. The method further includes the step of attaching the AC, DC and outlet plugs to their respective jacks on the control box. This aspect of the present invention is advantageous because each of the above steps may be performed by a person with limited electrical knowledge, thereby allowing that person to install an electrical system that conforms to ABYC standards including one or more electrical outlets into his or her vehicle very quickly and easily without any special tools or other expensive equipment.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective view of an exemplary power kit as installed in a pontoon boat;

FIG. 2 is a front view of an exemplary control box of the exemplary power kit;

FIG. 3 is a perspective and fragmentary view of the exemplary control box and showing a plurality of plug and jack combinations;

FIG. 4 is a perspective and fragmentary view showing an exemplary extension cord and 120 Volt to 240 Volt adapter;

FIG. 5 is a perspective and fragmentary view showing an exemplary outlet and an outlet plug of another exemplary outlet;

FIG. 6 is a perspective and elevation view of all of the components of the exemplary power kit;

FIG. 7 is a schematic view of the exemplary power kit as installed in a vehicle and electrically connected to an AC power source and a DC power source; and

FIG. 8 is a flow chart of an exemplary method of installing a power kit in a vehicle.

### DESCRIPTION OF THE ENABLING EMBODIMENT

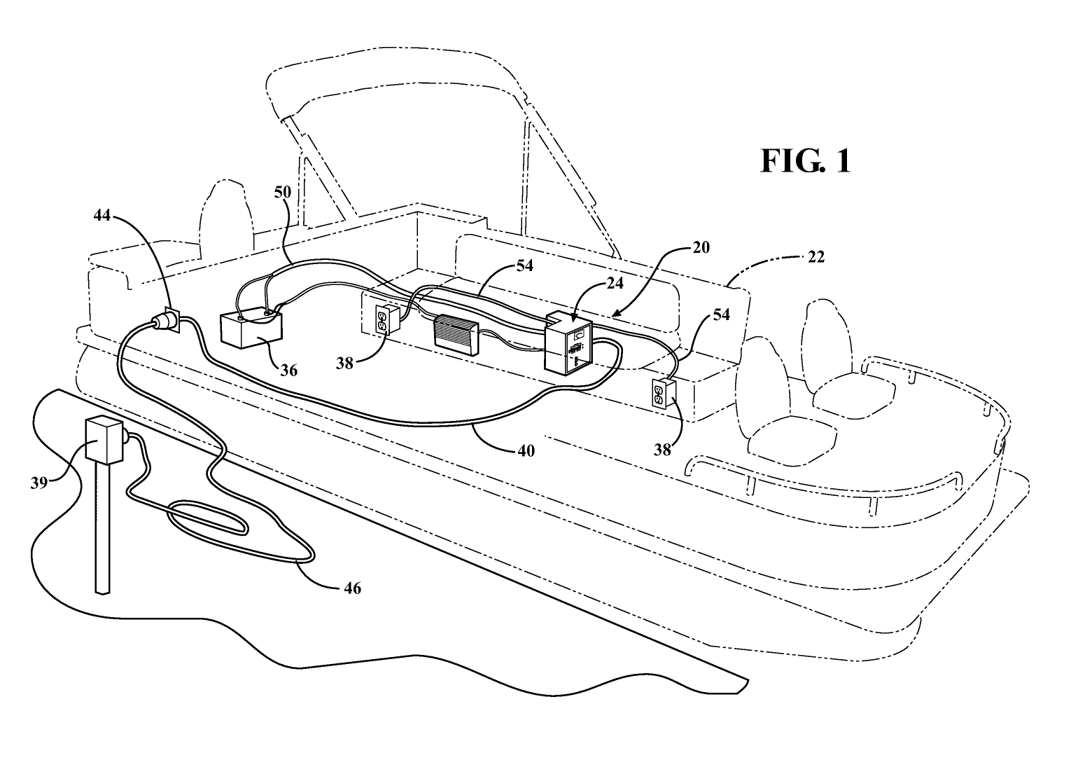

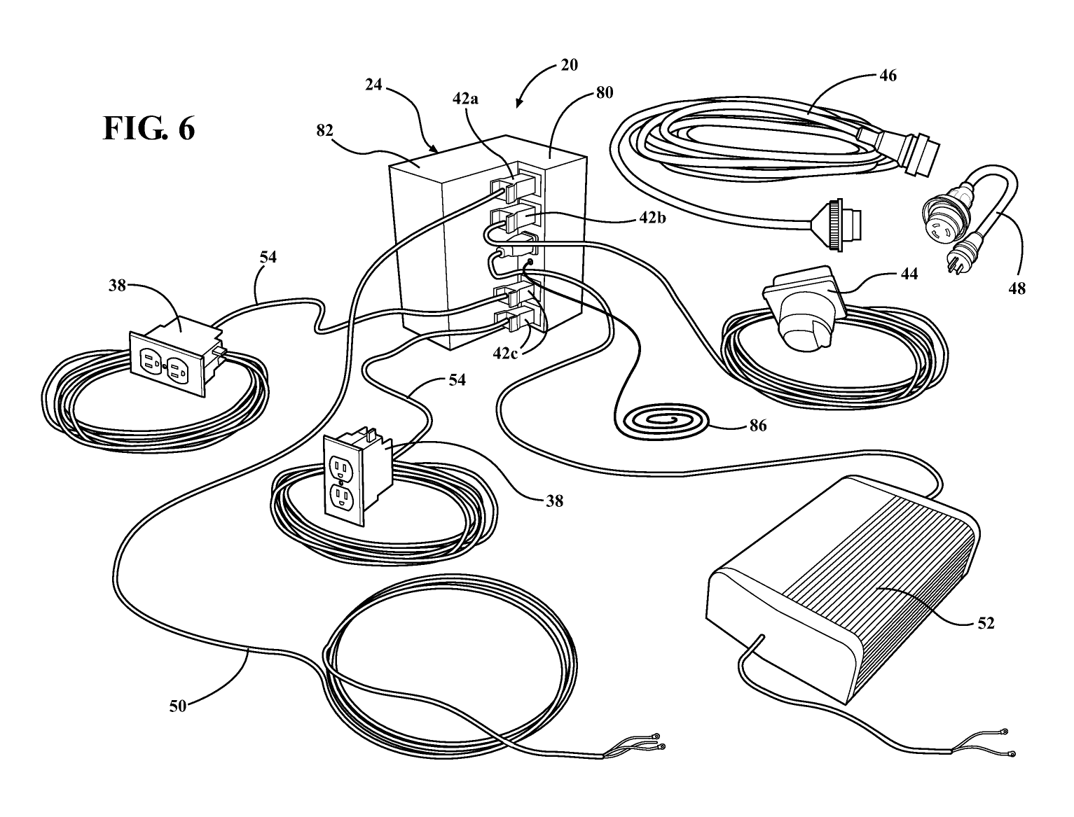

Referring to the Figures, wherein like numerals indicate corresponding parts throughout the several views, an exemplary power kit 20 for receiving and distributing electrical power is generally shown in FIG. 6 and is shown as installed in an exemplary pontoon boat 22 in FIG. 1. However, it should be appreciated that the power kit 20 could find uses in a range of other nautical or non-nautical vehicles including, for example, yachts, speed boats, sail boats, recreational vehicles (RVs), campers, conversion vans, etc. The power kit 20 is designed for easy and quick installation into any type of vehicle without any special tools or other expensive equipment and may even be installed by a person with limited knowledge of electrical systems. Additionally, the power kit 20 conforms to American Boat and Yacht Club (ABYC) safety standards for electrical systems in boats. As such, the power kit 20 is preferably packaged and sold as an aftermarket product. However, it should be appreciated that the power kit 20 could alternately be installed into a vehicle 22 in a factory setting or it could be installed into the vehicle 22 by a professional mechanic. As shown in FIG. 1, the exemplary power kit 20 includes a control box 24 which is electrically connected to the other components of the power kit 20 and serves as the proverbial “nerve center” of the electrical system. Specifically, the control box 24 receives electrical power from one or more power sources (such as a shore power outlet 39 and a battery 36) and distributes that power throughout the vehicle 22 according to a user's instructions.

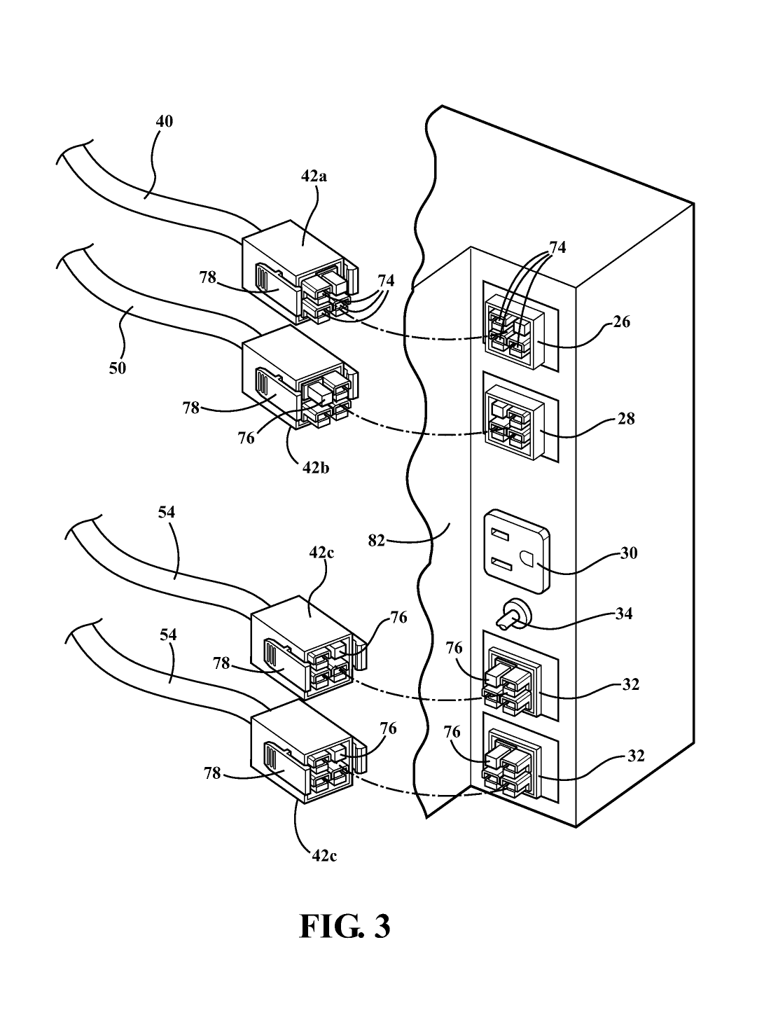

Referring now to FIG. 3, the exemplary control box 24 includes two electrical input jacks 26, 28, a battery charger jack 30, two outlet jacks 32 and an electrical ground point 34. One of the electrical input jacks 26, 28 is an AC input jack 26 configured for receiving alternating current (AC) from an AC power source (such as a power source on a dock or at a campsite) and the other is a DC input jack 28 configured for receiving direct current (DC) from a DC power source (such as a battery 36 in the vehicle). As shown in FIG. 1, a plurality of electrical outlets 38 are disposed in the passenger compartment of the vehicle 22 and are connected to the control box 24. A DC to AC inverter 37 (shown in FIG. 7) is disposed within the control box 24 for converting DC power into AC power when the control box is only connected to a DC power source. The outlet jacks 32 output AC power and are configured for to the outlets 38 (shown in FIG. 1) for powering various electronic devices (such as televisions, radios, laptop computers, etc.) in the vehicle 22. The control box 24 additionally includes a 240 Volt to 120 Volt transformer 41 (shown in FIG. 7) so that it can output 120 Volt AC power to the outlets 38 even when it is being supplied by 240 Volt AC power. As such, the control box 24 can receive a range of different power types (DC, 240 Volt AC and 120 Volt AC) and distribute 120 Volt AC power to the outlets 38 disposed in the passenger compartment of the vehicle 22.

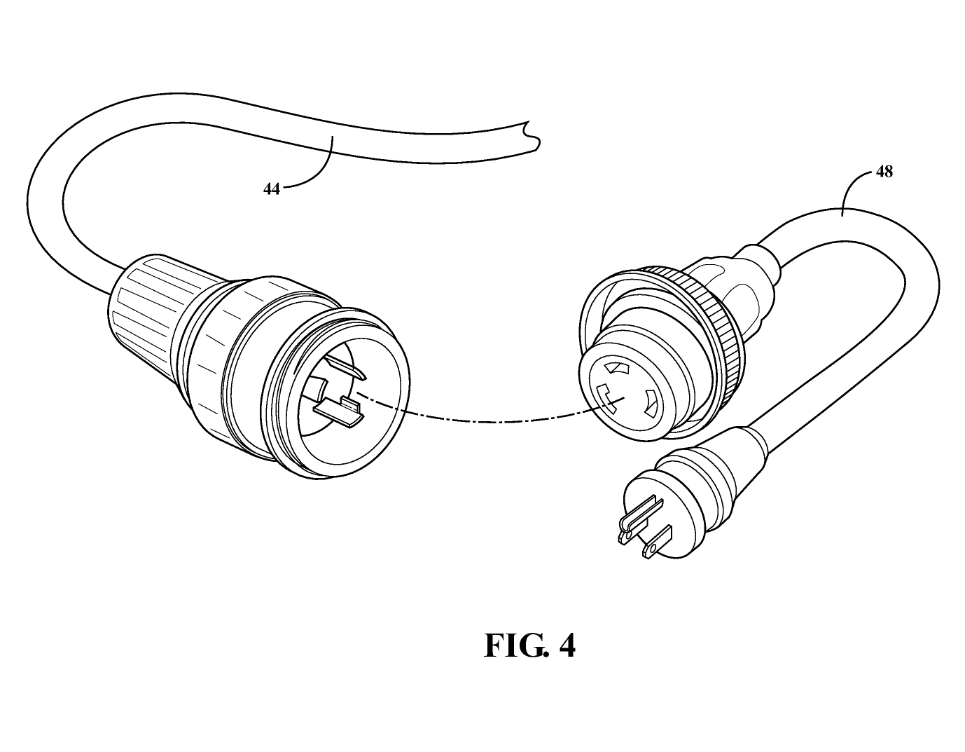

Referring still to FIG. 1, the exemplary power kit 20 additionally includes an AC cord 40 for conveying AC power from an external AC power source (shown in FIG. 1 as a shore power outlet 39) to the control box 24. One end of the AC cord 40 has a plug 42a which is configured for connection with the AC input jack 26 on the control box 24, and the other end has a socket 44 which is mounted on an exterior surface of the vehicle 22 for convenient connection to an external AC power source 39 via an extension cord 46 such as the 240 Volt extension cord 46, which is also included in the exemplary power kit 20. As shown in FIG. 4, the exemplary power kit 20 additionally includes a 120 Volt to 240 Volt adapter 48 which may be used to connect the extension cord 46 to 120 Volt AC power sources.

The exemplary power kit 20 also includes a DC cord 50 with a DC plug 42b on one end that is electrically connected to the control box 24 and positive and negative wires on the other end which are attached to the positive and negative terminals respectively of the vehicle's battery 36. When the vehicle 22 is away from an AC external power source 39 (such as when the vehicle 22 is in operation), a user may activate the control box 24 to draw DC power from the battery 36 and to convert it to AC power with the DC to AC inverter 37. If the battery 36 is also attached to an alternator (not shown) of an internal combustion engine (e.g. an outboard motor) as is common in many vehicles, this may not drain any power from the battery 36 while the engine is operating.

The exemplary power kit 20 also includes a battery charger 52 which is in electrical communication with the battery charger jack 30 on the control box 24 and also with the vehicle's battery 36. When the control box 24 is connected to an external AC power source 39, a user may activate the battery charger 52 to charge the battery 36 with power supplied by the external AC power source 39.

The exemplary power kit 20 additionally includes a pair of electrical outlets 38 which are electrically connected to the control box 24 via outlet cords 54 for providing 120 Volt AC power to the passenger compartment of the vehicle 22. For example, in the exemplary embodiment, the outlets 38 are mounted underneath seats in the pontoon boat 22. The outlets 38 are preferably ground-fault circuit interrupter (GFIC) outlets 38 for safety purposes, particularly if the power kit 20 is to be installed in any type of boat. It should be appreciated that these outlets 38 could be mounted in any desirable locations of the vehicle 22.

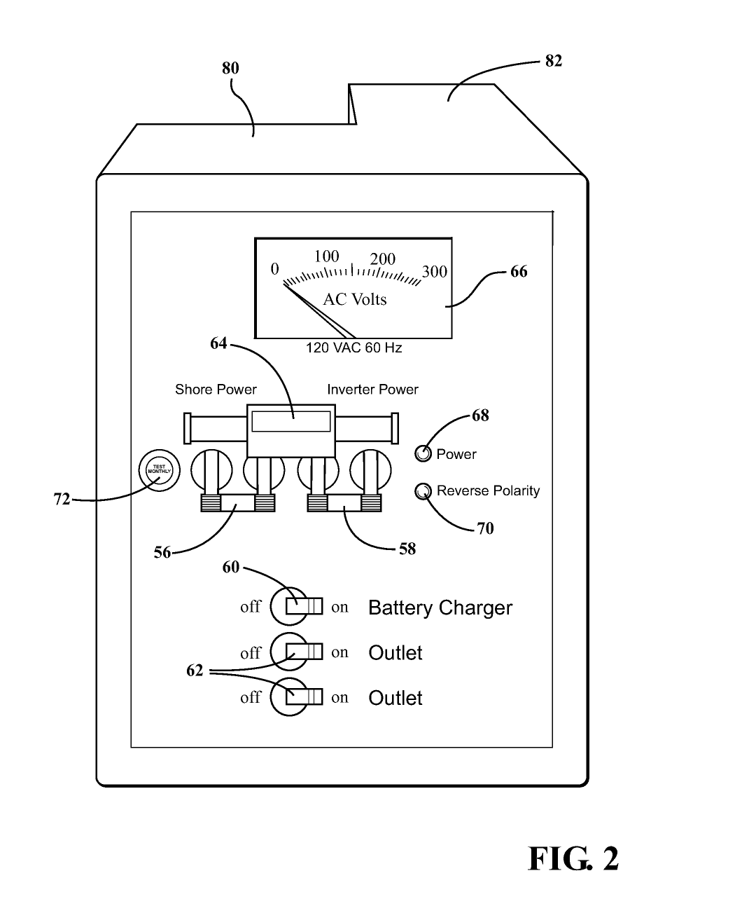

Referring now to FIG. 2, the front panel of the control box 24 is a control panel with a number of switches 56, 58, 60, 62 for controlling the power received into the control box 24 and distributed therefrom. Specifically, the exemplary control box 24 includes an AC power switch 56 (labeled as “Shore Power”) for operating the control box 24 with AC power from an external AC power source. The control box 24 also includes a DC power switch 58 (labeled as “Inverter Power”) for operating the control box 24 with DC power from the vehicle's battery 36. A switch blocker 64 is attached to the AC and DC power switches 56, 58 to prevent both of these switches 56, 58 from being turned “on” at the same time, i.e. the switch blocker 64 only allows the control box 24 to receive power from one power source at a time. The control box 24 also includes a battery charger switch 60 for selectively activating and deactivating the battery charger 52 and two outlet switches 62 for selectively activating and deactivating the outlets 38. The battery charger switch 60 may be configured to only allow the battery charger 52 to activate only if the AC power switch 56 is also activated. The front panel of the exemplary control box 24 also includes a voltage meter 66 which displays the voltage of the AC power being supplied by the control box 24 to the outlets 38 and to the battery charger 52. As such, a person may double-check that the control box 24 is outputting a proper voltage before plugging his or her electronic device into one of the outlets 38. Additionally, the front panel of the exemplary control box 24 includes a power indicator light 68 which illuminates when the control box 24 is receiving power from one of the power sources and a reverse polarity indicator light 70 which illuminates if the DC cord 50 is not properly connected to the vehicle's battery 36, e.g. if the positive and negative wires are connected to the wrong terminals of the battery 36. Even further, the exemplary control box 24 includes a test monthly indicator light 72 which illuminates every month to remind a user to test the electrical system. It should be appreciated that the control box 24 could include any desirable number or types of indicators for indicating different aspects of the electrical system's performance.

The control box 24, AC cord 40, DC cord 50, outlet cords 54 and battery charger 52 are all designed to be easily hidden from view of the passengers in the vehicle's passenger compartment. For example, in the exemplary pontoon boat 22, the control box 24 is disposed underneath a seat with a removable top so that it is both hidden from the normal view of the passengers but also easily accessible, and the AC, DC and outlet cords 40, 50, 54 are run underneath and between the seats and underneath the floor of the pontoon boat 22. However, it should be appreciated that the power kit 20 can be installed in the vehicle 22 in any desirable manner.

Referring now to FIG. 3, the plug and jack combinations are configured differently from one another such that the AC, DC and outlet plugs 42a, 42b, 42c can only be connected to their respective jacks 26, 28, 32 on the control box 24. As such, the AC and DC cords 40, 50 which supply power to the control box 24 cannot accidentally be connected to the outlet jacks 32, and the outlet cords 54 cannot accidentally be attached to the input jacks 26, 28. This not only makes the power kit 20 easier for a person to install in his or her vehicle but it also provides an important safety feature by protecting the control box 24 from damage that could occur if any or all of these cords 40, 50, 54 were incorrectly connected to the control box 24. In the exemplary embodiment, this is accomplished because the terminals 74 of the input jacks 26, 28 are configured differently than the terminals 74 of the outlet jacks 32. Specifically, the terminals 74 of the electrical input jacks 26, 28 are recessed into the control box 24, whereas the terminals 74 of the electrical output jacks 32 project outwardly. Likewise, the terminals 74 of the plugs 42a, 42b on the AC and DC cords 40, 50 project outwardly, whereas the terminals 74 of the outlet cords 54 are recessed within the plugs 42c. However, it should be appreciated that the plugs 42a, 42b, 42c of the AC, DC and outlet cords 40, 50, 54 and the electrical input jacks 26, 28 and outlet jacks 32 could be configured in any desirable manner to prevent the AC, DC and outlet cords 40, 50, 54 from being incorrectly connected to the control box 24.

Additionally, the exemplary power kit 20 is configured so that the AC cord 40 cannot accidentally be connected to the DC input jack 28 and vice versa. As such, the power kit 20 can be even more easily installed in a vehicle and is also resistant to problems that could arise if the AC and DC cords 40, 50 were improperly connected to the control box 24. In the exemplary embodiment, this feature is accomplished because the terminals 74 in the AC plug 42a are arranged similarly to the AC input jack 26 but differently than the terminals 74 of the DC plug 42b and the DC input jack 28. Specifically, the positive, negative and ground terminals 74 of the AC plug 42a and the AC input jack 26 are arranged in a different pattern than the terminals 74 of the DC plug 42b and the DC input jack 28. Additionally, each of these plugs 42a, 42b and input jacks 26, 28 includes a spacer 76, and the spacer 76 is located in a different location for the AC plug 42a and AC input jack 26 than it is for the DC plug 42b and DC input jack 28. This particular configuration is also advantageous as it allows for the above-discussed convenience and safety advantages while also allowing for similar terminals 74 to be used for the various plugs 42a, 42b, 42c of the AC, DC and outlet cords 40, 50, 54 and also for the input and outlet jacks 26, 28, 32 on the control box 24. Even further, this feature ensures that the AC and DC plugs 42 can only be connected to their respective input jacks 26, 28 in the proper orientation, i.e. with the positive terminals 74 connected to one another, the negative terminals 74 connected to one another and the ground terminals 74 connected to one another. The use of similar terminals 74 for these components leads to cost savings advantages through economies of scale. However, it should be appreciated that the plugs 42a, 42b, 42c and input and outlet jacks 26, 28, 32 could have other configurations to accomplish the same objective. The exemplary plugs 42a, 42b, 42c have deflectable fingers 78 for engaging their respective jacks 26, 28, 32 to more securely lock the plugs 42a, 42b, 42c to the control box 24. The fingers 78 also snap into engagement with a lip on their respective jacks 26, 28, 32 to provide an audible indication of a proper connection.

In order to facilitate its placement in an out-of-sight location within the vehicle while also allowing a user to easily access the various switches 56, 58, 60, 62 and indicator lights 68, 70, 72 on the control box 24 and to the input, battery charger and outlet jacks 26, 28, 30, 32, the exemplary control box 24 has a space-conserving shape. Specifically, the control box 24 is generally L-shaped, and the electrical input, battery charger and outlet jacks 26, 28, 30, 32 are all disposed on the short leg 80 of the L-shape and on the surface facing the direction in which the long leg 82 extends. As such, the control box 24 has an ergonomic shape which can fit within very small constraints in the vehicle. For example, in FIG. 1, the control box 24 is positioned underneath one of the seats in the exemplary pontoon boat 22.

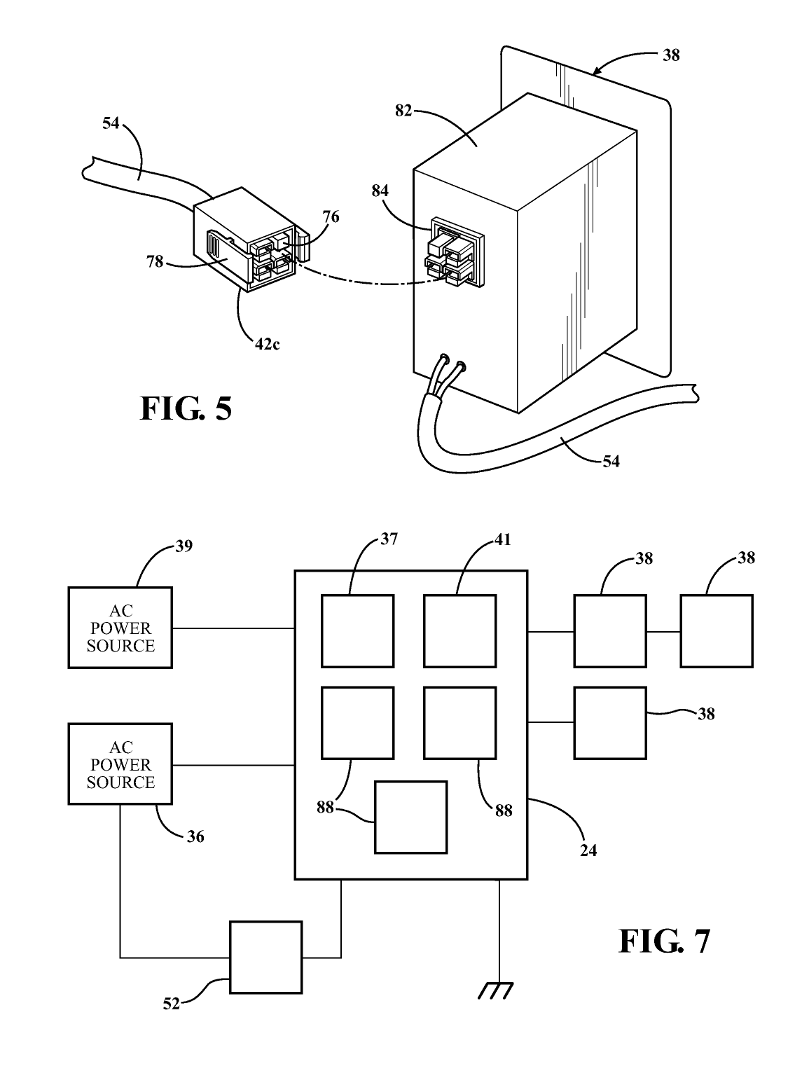

Referring now to FIG. 5, the exemplary outlets 38 include outlet box 82 with an outlet jack 84 which is configured similarly to the outlet jacks 32 on the control box 24. An outlet plug 42c of an additional outlet cord 54 may be attached to this outlet jack 84 to provide power to another outlet 38. As such, two or more outlets 38 can be attached to the control box 24 in series with one another, i.e. in a “daisy chain” type of connection. This is yet another advantageous feature of the exemplary power kit 20 since a user may quickly, easily and safely install any desirable number of outlets 38 into his or her vehicle 22 without any modifications to the control box 24, the outlet cords 54 or the outlets 38.

As shown in FIG. 6, the exemplary control box 24 additionally includes a ground wire 86 attached to the ground point 34 for electrically grounding the control box 24 to a grounded component of the vehicle 22. The ground wire 86 could be attached to, for example, a pontoon on the pontoon boat 22. Referring now to FIG. 7, the exemplary control box 24 also includes a plurality of circuit breakers 88 associated with the battery charger jack 30 and each of the outlet jacks 32 for interrupting electrical flow out of the respective jacks 26, 28, 30, 32 in response to an electrical short or an overload. Alternately, the control box 24 may include one or more fuses rather than circuit breakers 88. These safety features are particularly advantageous for power kits 20 that are installed into boats as they protect the control box 24 and the occupants in the boat in the event that water short circuits an electronic component.

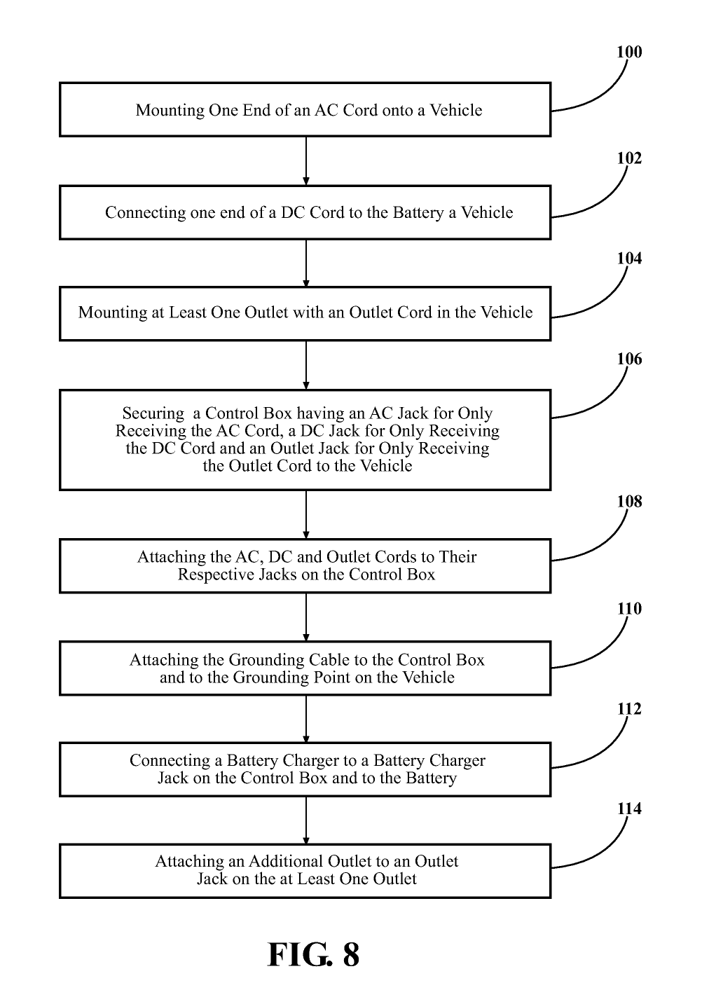

Referring now to the flow chart of FIG. 8 and to the structure of FIGS. 1-6, another aspect of the present invention provides for a method of installing a power kit 20 in a vehicle 22 having a battery 36 and a passenger compartment. The method includes the step 100 of mounting one end of an AC cord 40 onto an exterior surface of the vehicle 22 for attachment to an external power source 39 and wherein the other end of the AC cord 40 has an AC plug 42a. The method continues with the step 102 of connecting one end of a DC cord 50 to the battery 36 of the vehicle 22 and wherein the other end of the DC cord 50 has a DC plug 42b. The method proceeds with the step 104 of mounting at least one outlet 38 having an outlet cord 54 with an outlet plug 42c into a position within the passenger compartment of the vehicle 22. The method then continues with the step 106 of securing a control box 24 to the vehicle 22, and wherein the control box has an AC input jack 26 configured to only receive the AC plug 42a of the AC cord 40, a DC input jack 28 configured to only receive the DC plug 42b of the DC cord 50 and at least one outlet jack 32 configured to only receive the outlet plug 42c of the outlet cord 54. The method continues with the step 108 of attaching the AC, DC and outlet plugs 42a, 42b, 42c to their respective jacks 26, 28, 32 on the control box 24. The method may additionally include the steps 110, 112 of attaching an electrical grounding cable 86 to the control box 24 and to a ground point on the vehicle 22 and of connecting a battery charger 52 to a battery charger jack 30 on the control box 24 and to the battery 36 of the vehicle 22. Even further, the method may include the step 114 of attaching an additional outlet 38 to an outlet jack 84 on the at least one outlet 38. As such, any desirable number of outlets 38 can be connected to the control box 24 via the other outlets 38.

Obviously, many modifications and variations of the present invention are possible in light of the above teachings and may be practiced otherwise than as specifically described while within the scope of the appended claims.

What is claimed is:

1. A power kit for receiving and distributing electricity in a vehicle, comprising:
a control box including an AC input jack for receiving electrical power from an AC power source, a DC input jack for receiving electrical power from a DC power source and at least one electrical outlet jack;
at least one outlet and an outlet cord with an outlet plug configured for connection to said at least one outlet jack;
an AC cord including an AC plug for supplying AC electrical power to said control box;
a DC cord including a DC plug for supplying DC electrical power to said control box;
said control box including a DC to AC inverter for converting DC electrical power to AC electrical power to be supplied to said at least one outlet when said control box is only receiving electrical power from the DC power source; and
wherein said plug and jack combinations are configured differently from one another so that said outlet, AC and DC plugs can only be connected to their respective jacks on said control box.

2. The power kit as set forth in claim 1 wherein said AC and DC plugs include terminals that project outwardly and said AC and DC jacks include terminals that are recessed into said control box and wherein said outlet cord includes terminals that are recessed into said outlet plug and said outlet jack includes terminals that project outwardly.

3. The power kit as set forth in claim 2 wherein said terminals of said AC plug and AC jack are arranged in a different pattern than said terminals of said DC plug and DC jack such that said AC plug can only be connected to said AC jack and said DC plug can only be connected to said DC jack.

4. The power kit as set forth in claim 3 wherein each of said AC and DC plugs includes a spacer arranged with said terminals and wherein said spacer is in a different location of said AC plug than said DC plug.

5. The power kit as set forth in claim 1 wherein said AC, DC and outlet plugs include fingers that snap-fit into engagement with said AC, DC and outlet jacks respectively on said control box when properly connected.

6. The power kit as set forth in claim 1 wherein said control box includes at least one controller for selecting the power source on which it operates.

7. The power kit as set forth in claim 1 wherein said controller for selecting the power source on which said control box operates is further defined as a pair of switches including an AC switch for operating said control box with AC power from an external power source and a DC switch for operating said control box with DC power from the battery.

8. The power kit as set forth in claim 7 further including a switch blocker for preventing both of said AC and DC switches to be turned to an on position at the same time.

9. A method of installing a power kit in a vehicle having a battery and a passenger compartment, comprising the steps of:
mounting one end of an AC cord on an exterior surface of the vehicle for attachment to an external power source and wherein the other end of the AC cord has an AC plug;
connecting one end of a DC cord to the battery of the vehicle and wherein the other end of the DC cord has a DC plug;
mounting at least one outlet having an outlet cord with an outlet plug into a position within the passenger compartment;
securing a control box to the vehicle, and wherein the control box has an AC input jack configured to only receive the AC plug of the AC cord and a DC input jack configured to only receive the DC plug of the DC cord and an outlet jack configured to only receive the outlet plug of the outlet cord; and
attaching the AC, DC and outlet plugs to their respective jacks on the control box.

10. The method as set forth in claim 9 further including the step of attaching an electrical grounding cable to the control box and to a ground point on the vehicle.

11. The method as set forth in claim 9 wherein the control box further includes a battery charger outlet and further including the step of connecting a battery charger to the battery charger outlet on the control box and to the battery of the vehicle.

12. The method as set forth in claim 9 further including the step of connecting an additional outlet to an outlet jack on the at least one outlet.

13. A power kit for receiving and distributing electricity in a vehicle having a passenger compartment, comprising:
a control box including at least two input jacks for receiving electrical power from at least two power sources and at least one outlet jack for distributing electrical power to an outlet disposed in the passenger compartment of the vehicle;
at least two outlets with each outlet being electrically connected to an outlet cord having an outlet plug that is configured for attachment to said at least one outlet jack on said control box; and
wherein each of said outlets further includes an outlet box with an outlet jack shaped similarly to said at least one outlet jack on said control box for receiving said outlet plug of the other of said outlets so that each of said outlets is connectable to either said control box directly or to said control box via the other of said outlets.

14. The power kit as set forth in claim 13 wherein said outlet jacks on said control box and said outlet box each include a plurality of terminals projecting outwardly and wherein said outlet plugs of said outlet cords each include a plurality of recessed terminals for mating with said projecting terminals.

15. The power kit as set forth in claim 13 wherein said control box includes at least two outlet jacks.

16. A power kit for receiving and distributing electricity in a vehicle having a passenger compartment, comprising:
a control box including at least one input jack for receiving electrical power from at least one electrical source and at least one outlet jack for distributing electrical power to an outlet in the passenger compartment of the vehicle;
at least one electrical input cord configured for attachment to said at least one input jack on said control box and at least one electrical outlet cord configured for attachment to said at least one outlet jack on said control box; and
wherein said control box has an L-shape with a long leg and a short leg extending generally orthogonally to one another and wherein said input and outlet jacks are disposed on a surface of said short leg facing the direction of which said long leg extends.

17. The power kit as set forth in claim 16 wherein said at least one input jack is further defined as an AC input jack for receiving electrical power from an external AC power source and a DC input jack for receiving electrical power from a battery and wherein said at least one electrical input cord is further defined as an AC cord for delivering AC power to said AC input jack and a DC cord for delivering DC power to said DC input jack.

18. The power kit as set forth in claim 16 wherein said control box includes an electrical grounding point adjacent said input and outlet jacks on said surface of said short leg.

19. The power kit as set forth in claim 18 wherein said control box includes a battery charger jack adjacent said input and outlet jacks on said surface of said short leg.

20. The power kit as set forth in claim 16 wherein said control box includes at least one switch for controlling the flow of electricity into and out of said control box and wherein said at least one switch is disposed on a surface of said short leg opposite of said input and outlet jacks.

21. The power kit as set forth in claim 20 wherein said at least one input jack is further defined as an AC input jack for receiving AC power from an external AC power source and a DC input jack for receiving DC power from a battery and wherein said at least one switch includes an AC power switch for operating said control box on AC power and a DC power switch for operating said control box on DC power.

22. The power kit as set forth in claim 21 further including a switch blocker attached to said AC power switch and said DC power switch for only allowing one of said AC and DC power switches to be activated at a time.

23. The power kit as set forth in claim 20 wherein said at least one switch includes at least one outlet switch for controlling the supply of power to said at least one outlet.

24. The power kit as set forth in claim 20 wherein said control box includes a battery charger jack disposed adjacent said input and outlet jacks on said surface of said short leg and further including a battery charger connected to said battery charger jack and wherein said at least one switch includes a battery charger switch for controlling the supply of power to said battery charger.
